(19) United States
(12) Patent Application Publication
(10) Pub. No.: US 2024/0115985 A1
(43) Pub. Date: Apr. 11, 2024

(54) FILTER ELEMENT AND FILTER BODY THEREOF

(71) Applicant: Tien-Tse Hsieh, Tainan City (TW)

(72) Inventor: Tien-Tse Hsieh, Tainan City (TW)

(21) Appl. No.: 18/480,581

(22) Filed: Oct. 4, 2023

Related U.S. Application Data
(60) Provisional application No. 63/413,672, filed on Oct. 6, 2022.

(51) Int. Cl. B01D 46/40; B01D 46/00

(52) U.S. Cl. CPC B01D 46/403; B01D 46/0005

(57) ABSTRACT

A filter element and a filter body thereof are disclosed. The filter element includes a support body and a filter body. The filter body includes a laminated elastic filter fabric composed of plural layers. Two sides of the elastic filter fabric are bonded together so that the elastic filter fabric is coiled to form a central hole therein. The filter body is elastically fitted on the support body via the central hole. The filter body covers the vents.

### CROSS REFERENCE TO RELATED APPLICATIONS

This application claims the benefit of U.S. Provisional Application No. 63/413,672, filed Oct. 6, 2022.

### FIELD OF THE INVENTION

The present invention relates to a filter element and a filter body thereof, in particular to a filter element suitable for use in small or portable air filter device, having the advantages of easy production, low cost and good filtration.

### BACKGROUND OF THE INVENTION

FIG. 10 shows a conventional filter element 100. The function of the filter element 100 is to filter particles, particulates or other impurities in the air to obtain pure air. The filter element 100 includes two parts. One is a hard filter body 110, and the other is a sealant 120. The sealant 120 is configured to cover and seal the filter body 110 to ensure that leakage or contamination does not occur during the filtration process. The sealant 120 is usually disposable. Once it is used, it cannot be reused. After the filtration process, the entire filter element 100 is discarded as waste, resulting in a large amount of waste. This not only increases the cost of use, but also increases the cost of waste disposal, which is the main problem to be solved by the present invention.

Accordingly, the inventor of the present invention has devoted himself based on his many years of practical experiences to solve these problems.

### SUMMARY OF THE INVENTION

In view of the foregoing deficiencies of the prior art, the technical problem to be solved by the present invention is to provide a filter element, a filter body, and a method for manufacturing the same.

According to one aspect of the present invention, a filter body is provided. The filter body is mounted to a support body. The support body includes a front end portion, a rear end portion opposite to the front end portion, a plurality of support ribs connected between the front end portion and the rear end portion, and a plurality of vents each defined between every adjacent two of the support ribs. The rear end portion has an opening. The vents communicate with the rear end portion. The filter body includes a laminated elastic filter fabric composed of plural layers. The elastic filter fabric includes a first non-woven fabric layer, an activated carbon layer, at least one melt-blown fabric layer, and a second non-woven fabric layer. Two sides of the elastic filter fabric are bonded together so that the filter body is coiled to form a central hole therein. The filter body is elastically fitted on the support ribs of the support body via the central hole. The filter body covers the vents.

According to another aspect of the present invention, a filter element is provided. The filter element comprises a support body and a filter body. The support body includes a front end portion, a rear end portion opposite to the front end portion, a plurality of support ribs connected between the front end portion and the rear end portion, and a plurality of vents each defined between every adjacent two of the support ribs. The rear end portion has an opening. The vents communicate with the rear end portion. The filter body includes a laminated elastic filter fabric composed of plural layers. Two sides of the elastic filter fabric are bonded together so that the elastic filter fabric is coiled to form a central hole therein. The filter body is elastically fitted on the support ribs via the central hole. The filter body covers the vents.

Preferably, the support body is installed at a mouth and nose position of a safety helmet. The safety helmet includes a control unit, a power unit, and an air supply unit. The control unit is electrically connected to the power unit and the air supply unit. The support body faces the air supply unit for air to pass through the filter body and flow to the safety helmet.

Preferably, the filter element is applied to a portable air filter device. The portable air filter device includes a controller, a fan, a nozzle, and a cover. The controller is connected to the fan. The nozzle is connected to one side of the fan. The rear end portion of the support body is connected to another side of the fan. The cover covers the support body and the filter body. When the fan blows air toward the nozzle, the air passes through the filter body and is filtered by the filter body.

Preferably, the support body further has a stop portion at a position where the front end portion is connected to the support ribs. The rear end portion is formed with external threads. The rear end portion is locked with a stopper. The filter body is clamped by the stop portion and the stopper.

Preferably, the front end portion of the support body has a hemispherical shape, and at least one support ring is annularly connected between the support ribs.

According to a further aspect of the present invention, a method for manufacturing a filter body is provided. The method comprises the steps of preparing a laminated elastic filter fabric composed of plural layers, wherein the elastic filter fabric has a first edge and an opposing second edge that are in contact with each other; thermally fusing the first edge and the second edge to form a bonding portion so that the elastic filter fabric is coiled to form a central hole therein.

Preferably, the elastic filter fabric includes a first non-woven fabric layer, an activated carbon layer, at least one melt-blown fabric layer and a second non-woven fabric layer that are laminated in sequence.

Preferably, the central hole and the bonding portion of the filter body extend in a same axial direction. The bonding portion protrudes from one side of the filter body.

The main feature of the present invention is that the filter body includes a laminated elastic filter fabric composed of plural layers. Two sides of the elastic filter fabric of the filter body are in contact with each other and bonded together to form a bonding portion, so that the filter body is coiled to form a central hole therein. The filter body is elastically fitted on the support body via the central hole, thereby forming a filter element. The filter element is cost-effective and has a good air filtering effect.

The invention as well as a preferred mode of use, further objectives and advantages thereof will be best understood by reference to the following detailed description of illustrative embodiments when read in conjunction with the accompanying drawings.

### BRIEF DESCRIPTION OF THE DRAWINGS

FIG. 1 is a perspective view according to an embodiment of the present invention;

FIG. 2 is an exploded view according to the embodiment of the present invention;

FIG. 3 is a schematic view illustrating the manufacturing process of the embodiment of the present invention;

FIG. 4 is a schematic view of a support body shown in dotted lines according to the embodiment of the present invention;

FIG. 5 is schematic view of another example of the support body according to the embodiment of the present invention;

FIG. 6 is a perspective view of the embodiment of the present invention applied to a portable air filter device;

FIG. 7 is an exploded view of FIG. 6;

FIG. 8 is a schematic view of the embodiment of the present invention applied to a safety helmet;

FIG. 9 is an exploded view according to the embodiment of the present invention mounted with a stopper; and

FIG. 10 is a schematic view of a conventional filter element.

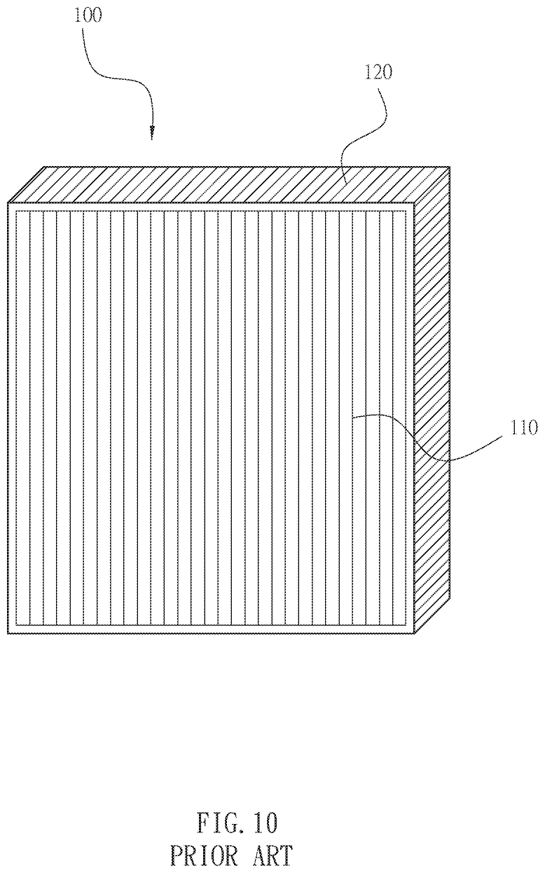

### DETAILED DESCRIPTION OF THE PREFERRED EMBODIMENTS

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

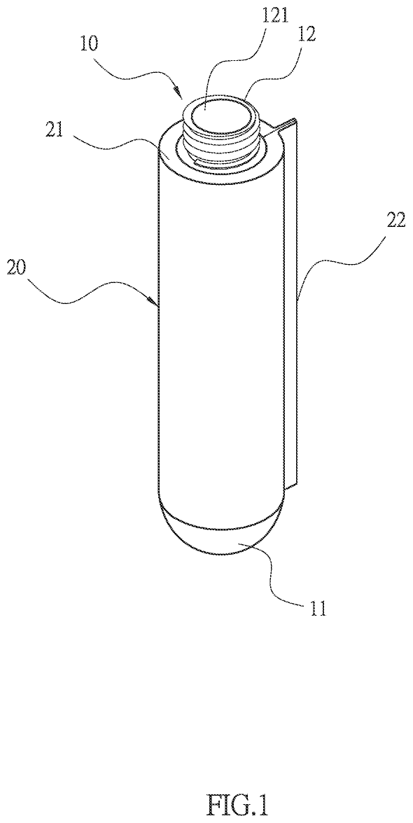

As shown in FIG. 1, a filter element according to an embodiment of the present invention comprises a support body 10 and a filter body 20. The support body 10 supports the filter body 20 for air circulation. The filter body 20 includes a laminated elastic filter fabric 21 composed of plural layers. Two sides of the elastic filter fabric 21 of the filter body 20 are in contact with each other and bonded together to form a bonding portion 22, so that the filter body 20 is coiled to form a central hole 23 therein. The central hole 23 and the bonding portion 22 of the filter body 20 extend in the same axial direction. The bonding portion 22 protrudes from one side of the filter body 20. The filter body 20 is elastically fitted on the support body 10 via the central hole 23, thereby forming a filter element that is cost-effective and has a good air filtering effect.

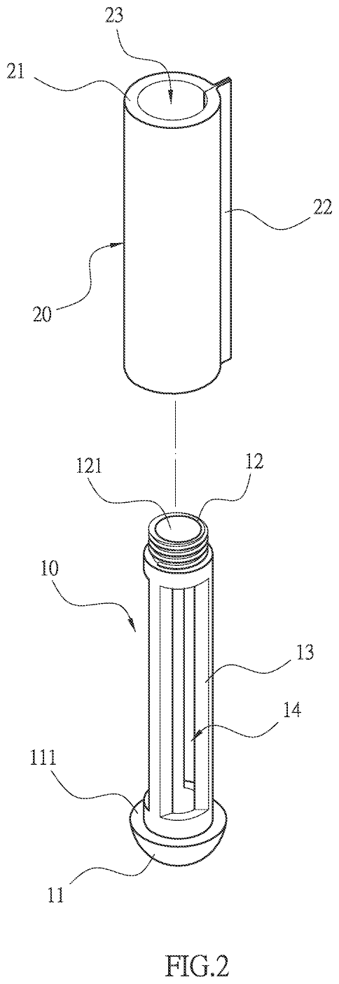

Further, as shown in FIG. 1 and FIG. 2, the support body 10 includes a front end portion 11, a rear end portion 12 opposite to the front end portion 11, a plurality of support ribs 13 connected between the front end portion 11 and the rear end portion 12, and a plurality of vents 14 each defined between every adjacent two of the support ribs 13. The front end portion 11 has a curved end surface. The rear end portion 12 has an opening 121. The vents 14 communicate with the rear end portion 12. The filter body 20 includes a laminated elastic filter fabric 21 composed of plural layers. Two sides of the elastic filter fabric 21 of the filter body 20 are in contact with each other and bonded together to form a bonding portion 22. The filter body 20 is elastically fitted on the support ribs 13, and the filter body 20 covers the vents 14.

The elastic filter fabric 21 may be a continuously conveyed fabric to be cut, coiled, and thermally fused in a continuous processing manner, so that the elastic filter fabric 21 forms the filter body 20 having the central hole 23 and the bonding portion 22 protruding from one side of the filter body 20. The bonding portion 22 and the filter body 20 are equal in length and relatively parallel. The elastic filter fabric 21 includes a first non-woven fabric layer 211, an activated carbon layer 212, at least one melt-blown fabric layer 213 and a second non-woven fabric layer 214 that are laminated in sequence. The melt-blown fabric layer 213 has the characteristics of high filtration efficiency, long service life and low pressure drop, which reduces the static pressure requirements of the fan used in conjunction with the filter element greatly. That is to say, a fan that is smaller, more energy-saving, lower noise, lower vibration, and lower weight can be used, and a smaller batteries can be provided. The filter element is especially applied to a small or portable filter device.

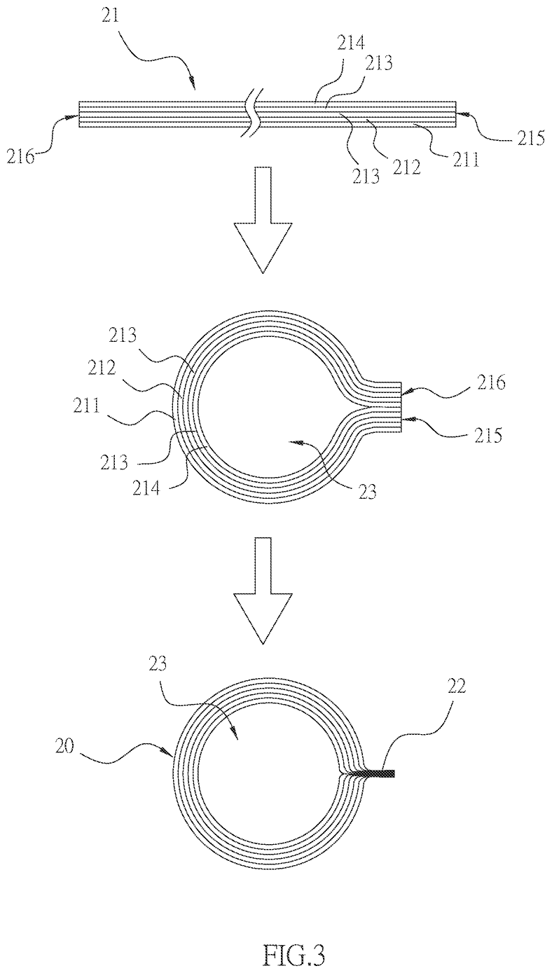

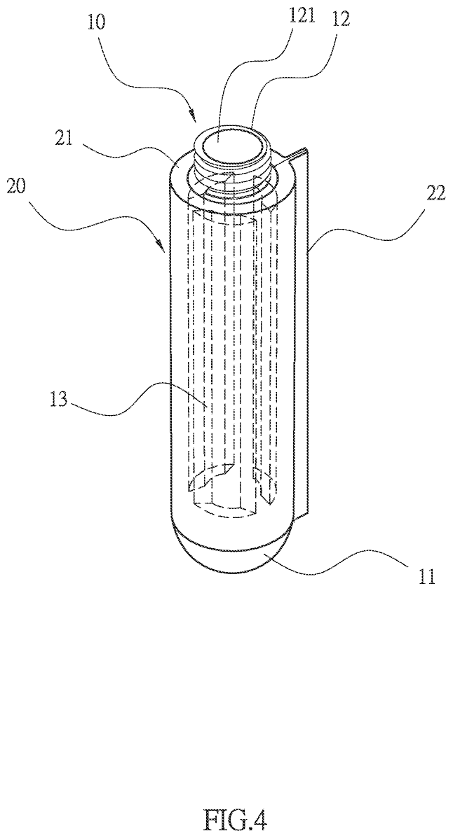

The method for manufacturing the filter element of this embodiment, as shown in FIG. 1 to FIG. 4, comprises the steps of preparing a support body, preparing a filter body, and assembling the support body and the filter body.

In the step of preparing the support body, the support body 10 includes a plurality of support ribs 13 and a plurality of vents 14 each defined between every adjacent two of the support ribs 13. The ends of the support ribs 13 are jointly connected to a front end portion 11. The other ends of the support ribs 13 are jointly connected to a rear end portion 12. The vents 14 communicate with the inside of the support body 10 and the rear end portion 12. The support body 10 may be made of plastics by injection molding.

The step of preparing the filter body includes:
A. preparing a laminated elastic filter fabric 21 composed of plural layers and cutting the elastic filter fabric 21 into a rectangular shape, wherein the elastic filter fabric 21 has a first edge 215 and an opposing second edge 216, in this embodiment, the first edge 215 and the second edge 216 may be opposing straight edges;
B. folding the elastic filter fabric 21 in half so that the first edge 215 and the second edge 216 overlap and contact each other;
C. thermally fusing the first edge 215 and the second edge 216 by ultrasonic welding to form a bonding portion 22, and coiling the elastic filter fabric 21 to form a filter body 20, wherein the filter body 20 has a central hole 23 therein, that is, the filter body 20 has a minimum volume shape with the same surface area.

In the step of assembling the support body and the filter body, the filter body 20 is fitted on the support body 10 via the central hole 23, and the filter body 20 covers the vents 14. Accordingly, the filter body 20 has the advantages that it is easy to obtain the elastic filter fabric 21 and the material cost is low. Moreover, the manufacturing process of the filter body 20 is also simple and convenient. It is worth noting that the filter body 20 is coiled and made of the elastic filter fabric 21 composed of plural layers, so the filter body 20 has a moderate degree of elasticity. The filter body 20 can be easily expanded to fit the support body 10. The elasticity of the filter body 20 is then utilized to tighten the support body 10. The structural strength of the support body 10 can support the filter body 20 to remain in the ideal position, so that the filter body 20 can be fully utilized for filtering air, and has the effect of easy replacement and low replacement cost. It is worth mentioning that since the filter body 20 has elasticity, when air is introduced through the vents 14 to the opening 121, the air pressure generated can cause the filter body 20 to further tighten the support body 10. When in use, there is no need for using the sealant. The present invention ensures that there is no leakage or contamination in the filtration process. Besides, since the sealant is not required, the filter body 20 can be easily installed and removed, and the support body 10 can be reused.

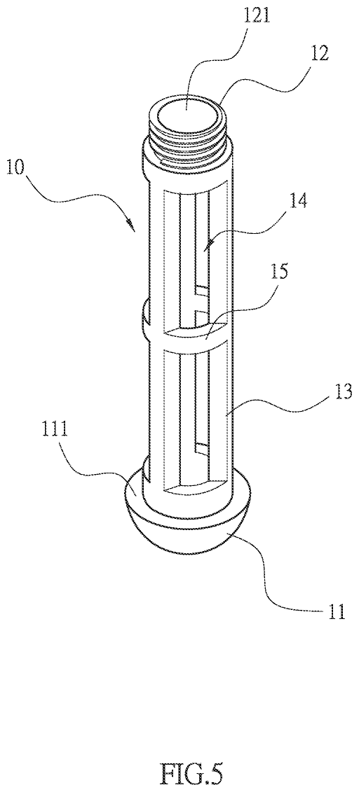

As shown in FIG. 5, at least one support ring 15 is annularly connected between the support ribs 13. Thus, without affecting the ventilation of the support body 10, the structural strength of the support ribs 13 is further strengthened, so as to prevent air leakage from the filter body 20 due to deformation of the support ribs 13, thereby improving the practicality effectively.

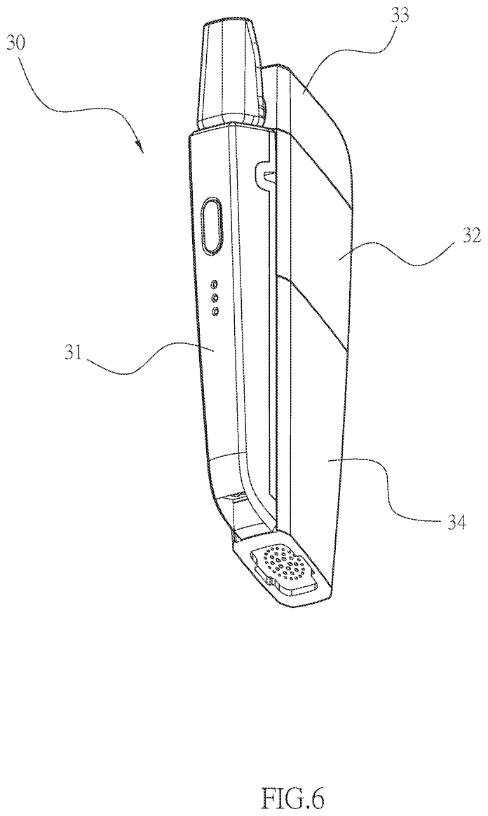

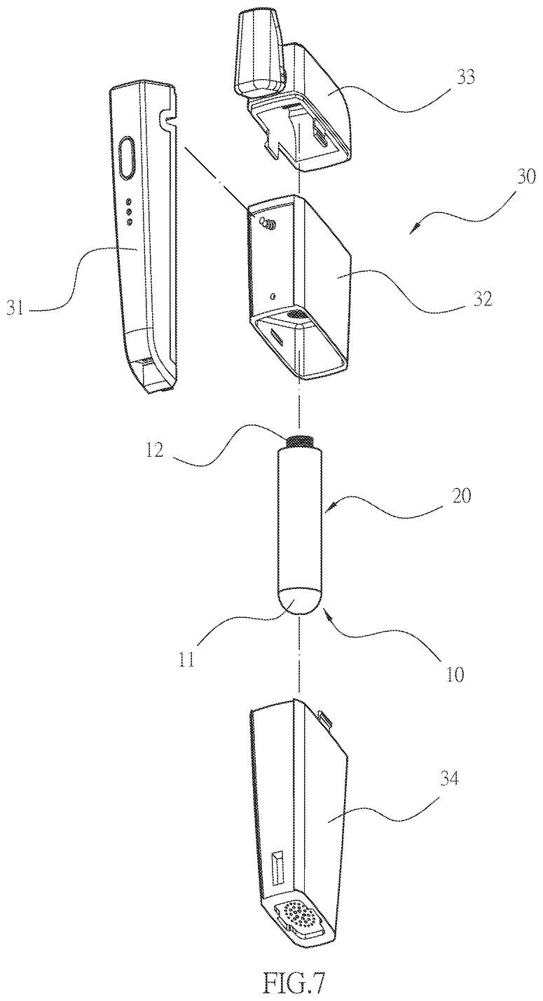

As shown in FIG. 6 and FIG. 7, the filter element is applied to a portable air filter device 30. The portable air filter device 30 comprises a controller 31, a fan 32, a nozzle 33, and a cover 34. The controller 31 is connected to the fan 32, which includes structural connection and electrical connection. The nozzle 33 is connected to one side of the fan 32. The rear end portion 12 of the support body 10 is connected to the other side of the fan 32. The filter body 20 is fitted on the support body 10. The cover 34 covers the support body 10 and the filter body 20. In other words, the air suction end of the fan 32 is fixed to the support body 10, and the air supply end of the fan 32 is fixed to the nozzle 33. When the fan 32 blows air toward the nozzle 33, the air passes through the filter body 20 to form an air filtering function. The front end portion 11 of the support body 10 has a hemispherical shape. When external air is introduced into the cover 34, the air will flow along the hemispherical front end portion 11 and be uniformly guided to the outside of the filter body 20, thereby improving the filtration efficiency.

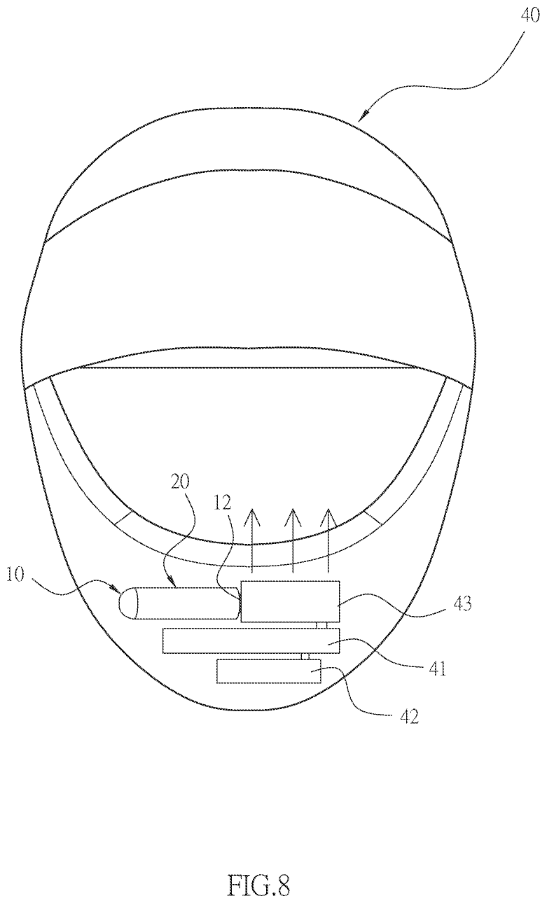

As shown in FIG. 8, the support body 10 is installed at a mouth and nose position of a safety helmet 40. The safety helmet 40 includes a control unit 41, a power unit 42, and an air supply unit 43. The control unit 41 is electrically connected to the power unit 42 and the air supply unit 43. The support body 10 faces the air suction end of the air supply unit 43 and allows air to pass through the filter body 20. The air supply end of the air supply unit 43 supplies air to the safety helmet 40, thereby providing another practical application, but not limited to the foregoing use.

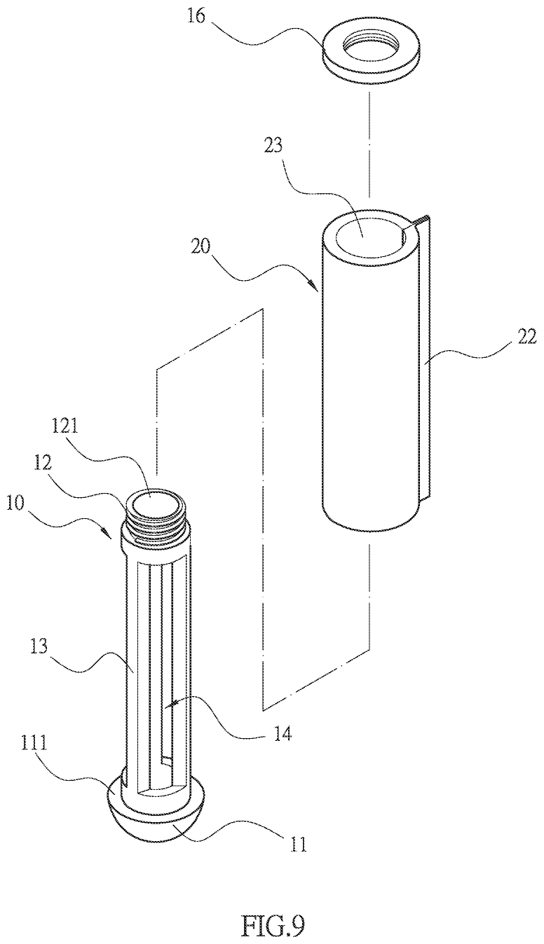

As shown in FIG. 9, a stop portion 111 may be formed at a position where the front end portion 11 is connected to the support ribs 13. The rear end portion 12 is formed with external threads. The rear end portion 12 is locked with a stopper 16. When the filter body 20 is fitted on the support body 10, one end of the central hole 23 of the filter body 20 is against the stop portion 111 to form an airtight effect. After that, the stopper 16 is screwed to the rear end portion 12, so that the stopper 16 is against the other end of the central hole 23 to form an airtight seal. That is, the filter body 20 is clamped by the stop portion 111 and the stopper 16, thereby maintaining sufficient airtightness before being assembled to any device, so as to effectively increase the variety of devices to which it is applicable. On the other hand, when it is necessary to replace the filter body 20, it is only necessary to unscrew the stopper 16 and apply force to detach the filter body 20 and the support body 10. Alternatively, the used filter body 20 can be easily destroyed by directly tearing the bonding portion 22 of the filter body 20. The filter body 20 can be easily replaced, thus providing a price advantage in terms of manufacturing cost and a convenience advantage in terms of assembly and replacement.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A filter element, comprising:
a support body, including a front end portion, a rear end portion opposite to the front end portion, a plurality of support ribs connected between the front end portion and the rear end portion, and a plurality of vents each defined between every adjacent two of the support ribs, the rear end portion having an opening, the vents communicating with the rear end portion; and
a filter body, including a laminated elastic filter fabric composed of plural layers, two sides of the elastic filter fabric being bonded together so that the elastic filter fabric is coiled to form a central hole therein, the filter body being elastically fitted on the support ribs via the central hole, the filter body covering the vents.

2. The filter element as claimed in claim 1, wherein the elastic filter fabric includes a first non-woven fabric layer, an activated carbon layer, at least one melt-blown fabric layer and a second non-woven fabric layer that are laminated in sequence.

3. The filter element as claimed in claim 1, wherein the support body is installed at a mouth and nose position of a safety helmet, the safety helmet includes a control unit, a power unit and an air supply unit, the control unit is electrically connected to the power unit and the air supply unit, and the support body corresponds to the air supply unit for air to pass through the filter body and flow to the safety helmet.

4. The filter element as claimed in claim 1, wherein the filter element is applied to a portable air filter device, the portable air filter device includes a controller, a fan, a nozzle and a cover, the controller is connected to the fan, the nozzle is connected to one side of the fan, the rear end portion of the support body is connected to another side of the fan, the cover covers the support body and the filter body, when the fan blows air toward the nozzle, the air passes through the filter body and is filtered by the filter body.

5. The filter element as claimed in claim 1, wherein the support body further has a stop portion at a position where the front end portion is connected to the support ribs, the rear end portion is formed with external threads, the rear end portion is locked with a stopper, and the filter body is clamped by the stop portion and the stopper.

6. The filter element as claimed in claim 1, wherein the front end portion of the support body has a hemispherical shape, and at least one support ring is annularly connected between the support ribs.

7. A filter body, mounted to a support body, the support body including a front end portion, a rear end portion opposite to the front end portion, a plurality of support ribs connected between the front end portion and the rear end portion, and a plurality of vents each defined between every adjacent two of the support ribs, the rear end portion having an opening, the vents communicating with the rear end portion, the filter body including a laminated elastic filter fabric composed of plural layers, the elastic filter fabric including a first non-woven fabric layer, an activated carbon layer, at least one melt-blown fabric layer and a second non-woven fabric layer, two sides of the elastic filter fabric being bonded together so that the elastic filter fabric is coiled to form a central hole therein, the filter body being elastically fitted on the support ribs of the support body via the central hole, the filter body covering the vents.

8. The filter body as claimed in claim 7, wherein the elastic filter fabric has a first edge and an opposing second edge that are in contact with each other and thermally fused to form a bonding portion, so that the elastic filter fabric is coiled to form the central hole.

9. The filter body as claimed in claim 8, wherein the central hole and the bonding portion extend in a same axial direction.

10. The filter body as claimed in claim 7, wherein the front end portion of the support body has a hemispherical shape, and at least one support ring is annularly connected between the support ribs.
